(19) United States
(12) Patent Application Publication
(10) Pub. No.: US 2020/0186689 A1
(43) Pub. Date: Jun. 11, 2020

(54) Automated Vehicle (AV) Interior Inspection Method and Device

(71) Applicants: Chris Outwater, Santa Barbara, CA (US); William Gibbens Redmann, Glendale, CA (US)

(72) Inventors: Chris Outwater, Santa Barbara, CA (US); William Gibbens Redmann, Glendale, CA (US)

(21) Appl. No.: 16/573,654

(22) Filed: Sep. 17, 2019

Related U.S. Application Data
(60) Provisional application No. 62/732,271, filed on Sep. 17, 2018.

(51) Int. Cl. H04N 5/225; H04N 5/235; H04N 5/247

(52) U.S. Cl. CPC H04N 5/2258; H04N 5/247; H04N 5/2354

(57) ABSTRACT

A fast and low cost method for inspecting a vehicle using a spectrum of visible and near visible electromagnetic radiation thus gathering digital images using sensors and filters to sense reflected light across a wide spectrum. The method includes breaking up the electromagnetic radiation into various segments; using the IR (the longer wavelength) end of the spectrum, through the visible range, and UV (the shorter wavelength) end of the spectrum. “visible light” high resolution photography alone can be a powerful tool for gathering evidence; however, both IR and UV photography that lie outside the visible range, can offer additional, valuable information and data about the state of the interior of a vehicle.

This application claims priority from U.S. Provisional Patent Application No. 62/732,271 filed Sep. 17, 2018. Application 62/732,271 is hereby incorporated by reference in its entirety.

### BACKGROUND

### Field of the Invention

The present invention relates generally to the field of automated vehicles (AVs) and more particularly to interior and exterior inspection of such vehicles.

### Description of the Problem Solved

As fully Automated Vehicles (AVs) come into the market they will become more popular and will be used by diverse groups of people for various transportation needs. The concept of Mobility as a Service will transform the global transportation industry. And the owners of the AV assets will all be faced with finding an inexpensive, rapid, secure and dependable inspection system for the interior and exterior of their AVs.

Part of the intrigue and attractiveness of AVs is that the vehicle does not need a human driver. The AV is essentially a robot that can pick up and deliver occupants and parcels as and when needed. Massive corporations will provide networks to manage and control large, likely diverse, fleets of AVs, including those compliant with ADA regulations. The manufacturer of the passenger vehicle, whether Ford or GM, Tesla, MBZ or VW/Audi, will not matter as much as the AV network service provider and its reputation for timeliness, convenience, transparency of fees, and for its loyalty programs and schedules and vehicle cleanliness.

In many ways, this will be like the airline industry in that the ordinary, day to day, occupant does not care whether he or she is flying in a Boeing or an Airbus. They care about the carrier and their pricing and convenience and cleanliness and safety record.

The owner of the AV, who is not physically present, will need to protect the value of their asset. On the other hand, the customer, or occupant, who is renting or leasing time in the vehicle will need to determine the state of the vehicle's exterior and interior when there may be no human present to validate the current state of the vehicle. The proposed interior inspection methods and devices offer an economical way to perform both normal, periodic inspection and cleaning for an AV owned by a single owner, or special inspections that are pre- and post-occupancy inspection process for shared vehicles.

Humans are generally messy creatures and they are sometimes prone to ingest or inhale substances that cause inexplicable behaviour. Certainly, one aspect of an AV is to allow the safe transport of passengers from point A to B without requiring a human driver. Thus, there will be many situations in which one or several occupants can and will be incapacitated and will not remember any activity that might have caused damage to the interior of the AV. Therefore, as vehicles become more automated, damage caused by humans will transfer more to the interior than to the exterior of the vehicle. Incoming occupants will care more about the state of the interior for health and safety reasons than the exterior. In addition, damage will be more obvious to the exterior of the vehicle than to the interior, which is filled with various materials, surfaces, shapes and shadows.

### SUMMARY OF THE INVENTION

The present invention proposes that the fastest and lowest cost method for inspecting a vehicle is with a spectrum of visible and near visible electromagnetic radiation. By this it is meant gathering digital images using sensors and filters to sense reflected light across a wide spectrum. The method includes breaking up the electromagnetic radiation into various segments; using the IR (the longer wavelength) end of the spectrum, through the visible range, and UV (the shorter wavelength) end of the spectrum. One skilled in the art of forensic investigations understands that “visible light” high resolution photography alone can be a powerful tool for gathering evidence; however, both IR and UV photography that lie outside the visible range, can offer additional, valuable information and data about the state of the interior of a vehicle.

### DESCRIPTION OF THE PREFERRED EMBODIMENTS

The present invention provides a fast and economical way to inspect the interior of a fully automatic vehicle (AV)). The present invention includes breaking up the electromagnetic radiation into various segments; using the IR (the longer wavelength) end of the spectrum, through the visible range, and UV (the shorter wavelength) end of the spectrum. “Visible light” high resolution photography alone can be a powerful tool for gathering evidence; however, both IR and UV photography that lie outside the visible range, can offer additional, valuable information and data about the state of the interior of a vehicle.

The interior of any modern vehicle is composed of a wide range of materials, including cloth fabrics, leather, faux leather for seat covers, plastics and woods and metals for dashboards, glass and mirrors, that all create a myriad of complex, reflective surfaces.

### The Camera Sensor and Filter and Lens Design

In one embodiment, the contemplated visible spectrum and near IR digital camera(s) with a wide field of view, for example 360°, will be mounted centrally in the ceiling of the cabin at or near the vehicle's interior central dome light. The camera(s) will be comprised of at least one or more sensors and at least one or more lenses that are designed to gather and focus light waves in the visible and near IR range of the spectrum. In addition, at least one LED light source with known characteristics will be placed at or near the camera(s), offering a source of broad spectrum light, similar to daylight.

The LEDs in one embodiment would flash and temporarily flood the interior of the vehicle with a broad spectrum of light, either from a single source, or from a number of narrow spectrum sources ranging from the IR through visible light and to UV light.

In another embodiment, two image sensors are used, there is no mechanism for moving a filter over a lens, one sensor is sensing visible light and the other sensor is sensing reflected, near IR light through an IR bandpass filter. The visible light sensor will, in a separate exposure, sense light reflected from the surfaces that are flooded with UV light and will gather and record any UV luminescence in the visible light range that is caused by the presence of organic materials. In a separate exposure the same visible image sensor will capture a normal image using a visible “daylight” source with a visible light source such as a “white” LED. This embodiment has two sensors, one filter, but three image captures in rapid succession, for example, in under one second total elapsed time there is: one capture for near IR with IR light source and IR filter over sensor, one capture of UV light source for any photo luminescence in the visible range with no filter, and one image capture with “white” LED light source and no filter over the sensor. The inventors feel that this combination will offer meaningful information about the state of the interior of the vehicle for the least amount of hardware investment and the least amount of inspection device maintenance.

In another more complicated embodiment, the system also has a rapid series of three exposures using a UV pass filter for one, and an IR pass filter for another, and a third exposure with no filter to capture the full visible range of the spectrum. This sensing system will be more complicated, including moving parts that hold the filters and move the filters over the sensor for each exposure. This embodiment will be more expensive than the previous embodiment that has two sensors and one stationary filter. In another embodiment with no moving parts, there can be three sensors, one with UV sensor and UV bandpass filter, one with IR sensor with IR bandpass filter and one sensor with no filter for visible light.

### One Sensor, Multi-Filter Embodiment

In another embodiment, a single, high definition image sensor is used. The broad spectrum of reflected light from the interior of the vehicle is filtered by a plurality of filters, in one embodiment there are 64 filters, each filter allowing a narrow band of wavelengths, for example 10 nanometers wide, to pass through the filter and reach the sensor that is divided into 64 different filtered sections. The broad spectrum light source could range from short wavelengths of 350 nm up to 850 nm in this embodiment.

The 64 images are combined to give one image that indicates the amplitude of light passed by each bandpass filter. This image can highlight various types of stains and damage to a wide variety of surfaces. The great advantage of this multi filter, single sensor inspection system is the ability to detect changes or damage to the interior even in high ambient daylight whose amplitude could overpower the device's artificial light source(s). This is a valuable feature because the inspection images could be captured under a variety of ambient lighting conditions, from very dim, night time, light to very bright midday light in an outdoor setting.

It is important to note that any number of images (and hence filters) can be deemed adequate for the inspection purposes. For example, 32 or 16 or 8 or 4 images with the corresponding filter range could be adequate for our purposes and less expensive to build.

Another embodiment with multi bandpass filters over one high definition image sensor, as described above, might also co-locate another high definition sensor that is not filtered, but simply takes a matching hi-def image at, or very near the same time as the filtered light exposure. With the proper spacing this sensor could also offer a stereo image of the scene and will add definition and resolution to the filtered, lower resolution, images gathered by the filtered exposure.

Another valuable feature for the multi filter approach as discussed above, is that this system is preferable for handling high dynamic range. In daylight especially, there might be very bright places flooded by sunlight, such as the edge of a seat, immediately adjacent to a dark, shadowed location such as the dark floor mat immediately in front of the seat. The camera's own artificial lighting would be drowned out by the bright sunlight, while the shadowed areas may reflect some of the artificial interior light that would act like “fill” light. It is possible that we will pulse the LED light sources and the sensors at the same frequency in order to diminish the ambient light crosstalk and gain more signal strength.

The envisioned camera sensor and multi filter technique would take advantage of the daylight when present. At night when natural sunlight is absent, the interior, broadband light, similar to sunlight, but much less powerful, would be used.

All of the above embodiments can use IR, visible light, and UV light to flood the interior of the vehicle for their corresponding exposure(s).

### Inspection Policy

Humans, in general, like to have their privacy and do not like to be monitored while in a vehicle. The monitoring of the AV will be published and agreed to by the occupants as a basic business policy disclosure. It might be required that the camera has a cover over the lens during the time that the vehicle is occupied and is moving. There will be an option not to monitor during use, but immediately after the trip, so that an inspection could quickly and efficiently notify AV HQs that an object, such as a wallet, or cell phone, or infant was left behind. The inspection image(s) might also indicate some sort of damage.

The less monitoring there is in the vehicle during the trip, the more need for thorough inspection of the vehicle at the end of the use period, or “end of trip”, by the occupant(s) or vehicle owners on record. Accountability must be based on secure, accurate, rapid and defensible, time-stamped data. Humans also tend to accept impartial, digital evidence of their activity. This system of accountability will save countless hours of dispute resolution between the responsible occupant and the vehicle owner.

The present invention envisions a case where a limited number of AVs are shared a by a limited, known number of owners who form a mobility community. The owners will trust that their fellow owners in the community will preserve the cleanliness of the vehicles; however, they will also want an inspection after each use to verify status of shared vehicle.

There will be various levels of monitoring AVs and their occupants. The present system comprises a real time monitoring camera placed in the cabin of the AV. However, to alleviate any occupant's protests of invasion of privacy that this camera might trigger, different levels of monitoring can be based on the asset owner's (note there could be multiple owners) and network provider's policy. There might be discounts offered if occupants know and agree that for security purposes they will be under surveillance during their trip. In larger sized, public vehicles, monitoring might be mandatory and welcomed by all occupants. The inspection camera(s) could be part of this monitoring system.

The present invention also contemplatse AV networks that offer anonymous travel, probably paid for in cryptocurrency. The proposed inspection system could be very valuable for assessing the state of the vehicle AFTER the occupant(s) have exited the vehicle. The anonymous occupant would agree in advance to a damage deposit once he or she has accepted the state of the vehicle they are using for their itinerary. If there is damage, an amount will be deducted from their security deposit. Anonymity of occupants could be tied to a “smart contract” that deducts fees from an account based on the state of the interior of the AV at end of trip.

### Data Processing and Deep Image Learning

The present invention contemplates building a library of images based on stains or damage to a wide number of common interior surfaces, such as seats, backrests, dashboards, floor mats, windows, etc., of all different types and colors under various lighting conditions. The library of images of known surfaces and stains can be used as data points to build a deep learning image recognition system, such as that used in Google's Clip.

It is contemplated that a deep learning vision technique could be used to determine the type of stains presenting on a wide variety of surfaces under daylight and/or artificial interior lighting, and in addition, determining how the stains might appear under varying amounts of ambient light.

### Inspection System Logic

An important aspect of the AV inspection system and method is to build a history and profile of the interior of the AV for each passenger occupancy commencing with the initial inspection documentation of a factory-new vehicle, prior to the very first “occupied” trip, and then to follow in sequence every passenger occupancy until the end of the service life for that vehicle. In other words, it is important to document the interior of the AV from the showroom “new car” state and then follow the state of the interior based on the access and use by each occupant or group of occupants for each trip. Essentially, a “chain of custody”. If this is not possible, one could begin with a “first inspection” start day and time in order to establish the state of the interior of a used vehicle. Each inspection image will be time and date stamped in order to maintain each vehicle's “chain of custody”, so that the most recent “responsible” occupant will be held financially accountable for any “new” interior damage or delay in service. The accountable period commencing at “end of trip” must be brief because the accountable occupant could claim that the damage took place some time after he/she exited the vehicle.

If there is a longer period of time, such as the AV driving without an occupant for a charging session, the inventors envision a method to create a bona fide occupancy hiatus. This is a period after a trip and following an occupancy by a person or animal in which no other person occupied the vehicle since the most recent trip and the inspection. This period could be substantial. Let us look at one use case. An owner, who may or may not be an occupant, uses the vehicle for a trip, arrives at his or her destination, such as a home or office and during this time, the AV is expected to have at least one charging session. But the AV has to queue up for the closest charger in the network. The system will need to sense that no other person has occupied the AV during this hiatus. This can be accomplished by sensing if a door has opened/closed, utilizing a camera, a motion sensor, seat sensors for sensing the presence of a person occupying a seat, and a sensor for any wireless device that an unknown occupant might possess and activate inside the AV.

Therefore, the “end of trip” can be based on several factors, such as GPS destination/location and vehicle in PARK and motor off, seat sensors or seat belts indicating “empty”, could be the trigger for the “end of trip” inspection image capture and timestamp. The inspection could be planned to take place during AV charging or refueling of any kind. A timestamp for end of trip will occur when all sensors mentioned above indicate an empty AV. This is also important in order to notify the most recent occupant(s), owner, or shared owner of any unintentionally “left behind” objects before they, or their AV travels too far from their “end of trip” destination point.

For the interior mounted inspection device, the most recent inspection images will be held locally in the camera storage device for a predetermined period of time, for example, the last dozen trips, and the latest records will be sent periodically from the device through wireless transmission to the vehicle dashboard as one option and then, also through wireless communications, such as cellular or WiFi or BLE, via a WAN to a remote central server where pattern recognition and end of trip image comparison will take place. In this manner, the latest images will be sent to the server, but also saved locally for 24 or 48 hours, for example, in case of a failure to communicate data to the remote servers.

In another embodiment, the image data is “datamuled” through the departing and/or incoming occupant's phone to the central server. The datamule process is discussed in detail later in this application. In this manner, any meaningful “change” and damage to the interior of the vehicle can be noted and documented. In addition, any valuables or “left behind” objects, other than disposable garbage, such as can, bottles, wrappers, diapers, etc., can be noted. Again, some state of dirtiness and messiness might be acceptable based on the policy of the owner of the AV asset. Zero tolerance and/or bad behavior could result in fines, extra fees, poor occupant ratings published to other car share companies, and/or customer account closures.

### Various Methods to Gather the AV Inspection Data May be Used

The present invention contemplates various scenarios for gathering data that determines the status of the AV.

One method, as discussed above, is with a fixed camera, or cameras, mounted in the overhead or ceiling of the vehicle in a central location, such as near the dome light. The camera could be fixed or could swivel and tilt, or could be attached to an articulating arm. If it is a larger vehicle, such as a passenger van, or tram or bus, there could be multiple cameras mounted along the ceiling of the AV. This method has the advantage of a vehicle self-inspection at any chosen time and place.

Another method is to have at least one camera and sensor attached to a robot arm that resides outside the vehicle in an inspection/charging area and reaches into the vehicle while the vehicle is parked at a designated AV inspection/charging center. Based on weather and security conditions, if the center is outdoors, or if indoor under controlled conditions, the AV's windows are lowered and the robot arm enters the AV to conduct a programmed interior inspection. Of course, the same robot arm could also carry out external AV inspections and this is one advantage of having an external robot arm instead of a fixed interior camera and sensor. The inventors contemplate that a system could also use both methods, the exterior robot for exterior inspection and the interior, fixed camera, for interior inspection.

Another embodiment has at least one drone with at least one camera and sensor mounted on the drone in order to inspect the interior and (optionally) the exterior of the vehicle. One of the sensors would be a sonar type sensor to measure distance from below or above the drone to assure safe maneuvering within the vehicle. The drone(s) could reside in a safe compartment in the interior of each AV. This method has various advantages: the drone can be programmed once for specific vehicle interiors, can be flexible and programmed for various different types of vehicles, can do interior and exterior inspection, can have very small batteries and very fast charge time due to very short duration inspection flight times.

In another embodiment of the drone method, the drone(s) could reside in a station, such as an electric AV charging or refueling station, sitting atop a pole, for example, in a vehicle inspection area. This has the advantage of being less costly than a drone or robot arm in each vehicle because a set of drones can be used to inspect multiple AVs.

Upon entering the refueling/inspection area, the windows of the AV are lowered enough to allow the inspection drone(s) to enter the vehicle and carry out controlled “fly around” of the interior of the AV. The “fleet” of AVs could all be the same model; however, the AVs could be different models with different interiors and exteriors. The interior of each type of AV, small, medium or large, would be programmed into the drone's allowed flight space memory. The type of AV and its ID would be transmitted via a wireless signal to the refueling station, which will likely be an EV charger, and also transmitted to the inspection device. Also, an exterior barcode, VIN, or RF signal, could be sensed and read by the drone(s), informing them which type of vehicle they are inspecting and the corresponding interior allowed flight space pattern. This also allows access to the “stain or damage” image library for that type of vehicle. Of course, exterior inspection could also be carried out by the same drone(s) in sequence, or additional drones at the same time.

One consideration for having inspection during refueling is that AVs will need to autonomously refuel from time to time based on location and access to charging/refueling sites. At that time it is possible to run an inspection, especially if the charge session and inspection comes just after an occupant has finished a trip. Using a shared AV as an example, the AV would not need to be inspected if it is sent for refueling during the same occupants possession time. For example, during a workday or at end of day and end of trip when returning to a residence, the AV might need refueling, but not necessarily require an inspection because the authorized access by the same person(s) has been continuous and unbroken.

The benefit of an interior-stationed drone, or interior fixed or telescoping inspection camera and sensor device, especially for smaller vehicles, is the ease and frequency of inspections and the time factor and the need to establish chain of custody and thus the occupant responsibility.

Although the inspection process does not need to take place within seconds of end of trip and end of occupancy, it should take place within minutes of an occupant's end of custody and end of trip, so that if some damage or difficult clean up, such as urine or vomit is present, the last responsible occupant can be notified of any damage and any resulting additional charges to their account or credit card. Various other types of damage could be: ripped or torn upholstery, a cracked window, a liquid splattered back of seat or drink splattered dashboard. In some cases, perhaps an unconscious occupant will be discovered during the “end of trip” inspection. Some Automated Vehicles will be traveling bedrooms, party rooms, offices, work out areas, etc., and could have commensurate damage and cleaning policies. In some cases, what happens “in vehicle” stays “in vehicle” unless some sort of criminal activity is alleged and can be proven or denied based on the inspection images, if required as a forensic tool. In other words, if a claim of criminal activity during a trip is filed, the preliminary inspection data is saved in a special file and the vehicle may not be allowed to proceed to the next trip because it is deemed a crime scene.

If there is an E stop and “let me out” as soon as safely possible RED button inside a shared AV, then triggering this RED event may also automatically trigger a image capture events.

The AV, based on company policy, can perform a variety of different tasks derived from the preliminary inspection from our proposed system. The first might be notifying a human inspector that he/she needs to look at the “new damage” image and decide whether to have a human inspect the vehicle. The human inspector could have a hand held camera similar to the one placed in the vehicle and take a new image and compare the new, close up, detailed image with the wide angle image from the vehicle. The following actions can be based on the confidence of the inspection reading, based on the previous state of the interior of the vehicle, based on air sample analysis (if requested) and also the type and status of the previous and the next occupant. A remote human inspector could also make decisions based on the inspection image(s) from the vehicle. And the remote human inspector could trigger further, more detailed, images from the vehicle based on IR, UV or visible light images and air samples.

In another embodiment, an air sampler is also used to sample the air in the cabin at the end of the trip and in approximately the same time frame as the inspection images are captured. It is also possible that air sampling is continuous or programmed for every few minute intervals. The air sampler will, of course, add cost to the system; however, in certain applications the air sampler will be deemed a good value and worth the added cost. One example is that in which an occupant was smoking a cigarette, inhaling a vapor device, but left no visible trace of smoke or ash or vapor inside the cabin. However, the vehicle smells as if someone had been smoking or vaping. The same could be said for alcohol or aromatic foods, or a powerful perfume that leaves undesirable odors, but that leaves no visible trace, especially if the offending occupant is careful not to spill or leave any trash. The unpleasant odor remains for the next occupant(s) who may even be allergic to some of the molecules in the cabin air.

The air sampler is comprised of a sample input tube, internal sampling pump, a sensing array, pattern recognition CPU and an optional process for determining the signature source of various organic chemicals, such as vomit, urine, smoke, etc. The device and input tube could be placed unobtrusively under a seat or bench seat in the vehicle. The air sampler could also be integrated into and an option in a drone or telescoping arm base station that resides full time in the vehicle, or that resides at a refueling/inspection station.

The camera image capture alone is valuable; however, the air sample results in conjunction with the camera images will be a powerful tool in determining damage or unwanted materials left in the vehicle. Both results can be correlated; for example, a damp floor mat, plus the detection of urea in the air sample indicates that urine is present in the vehicle. The same could be said for alcohol or coffee.

In one embodiment for air sampling, the drone or robot arm contains the air intake sampling device, which could be disposable, or recyclable, and that air sample cartridge is deposited in the sensing device that is stationary and analyzes the air sample locally and/or transmits data to a remote, secure database. This air sample analyzer could be in close proximity to the refueling station. Air sampling could be a backup or second analysis indicated if the visual analysis indicates some negative change status. For example, image analysis indicates a stain; therefore, initiate air sampling to learn the source of the stain. The knowledge of the source of the stain, or damage can lead to more efficient cleaning and repairs. Stain location and source of stain could be transmitted to a robotic cleaning device.

### Steps Taken to Inspect Vehicle Interior

There is a mechanism for noting “end of trip” and commencing inspection image capture. This can be based on GPS, zero seat (pressure) occupancy, vehicle in “park”, or request from occupant to capture image at end of trip. Based on the policy of the vehicle owner(s) and manager, the images may not be taken until after the occupant(s) have exited the vehicle. This also is logical because the disembarked occupant(s) could have no further effect on the interior of the vehicle and also would not interfere with the inspection image. As mentioned, this mechanism can be triggered by a GPS destination, the vehicle stopped and in park, seat belts disengaged, seat pressure monitors at “zero/empty” or a seat pressure reading that is more than zero but less than occupied by a passenger during trip, door(s) open and closed. A small package, cell phone, or even a child could be left behind. Any combination of factors based on the owner/manager's policy can trigger the inspection image capture.

If the successfully sent image is blank or black, this would indicate that the camera(s) have been blocked or masked in some manner by the occupant on record and will trigger an alarm for further steps and remote or local human intervention into the inspection process.

Next, the images are taken simultaneously, or in series, depending on the design of the hardware. The images are temporarily stored in the cameras storage device, such as a flash drive. This drive could store a number of the most recent images from the vehicle and send and delete the oldest images, which likely will have less value after some predetermined period, for example a week or a month. The newest images will be sent and saved and the oldest images will be deleted so that the flash drive remains within a safe percentage of full, for example 80%, of being full. The camera control system will be programmed to never refuse to take new images due to an overfilled flash drive.

In one embodiment with an interior, fixed inspection camera, the images can be processed locally, within the camera's CPU, in order to determine differences from the previous trip images. Or, the images can be sent via a wireless LAN connection to the vehicle “dashboard” in order to be sent via wireless WAN to a “cloud based” image processing and pattern recognition remote processor and server. In the short term, a human observer could study the images for any damage to the interior of the vehicle. In the long term, after a period, for example 90 days, of development and data access, a pattern recognition will be trained to look for interior “negative changes”. If damage is noted, the system can flag the network operator that there is a noticeable “negative change” within the vehicle. At this time a remote human observer could view and study the image(s) on a dashboard showing a group of vehicle interior images, and the operator could have the option of requesting an air sample and also further images from the vehicle inspection camera(s) if the vehicle is in communication with the human observer.

In another embodiment using a robot arm for inspection, the gathered image data can be sent via a wired or wireless system directly to a “cloud based” image processing and pattern recognition remote processor and server. There would be no need to communicate with the dashboard of the AV. The same could be said for the drone inspection system, if based at a fixed AV refueling and/or inspection location. The images of the interior could be downloaded wired or wirelessly from the drone's image storage device to a receiver in the drone re-charging station. Again, this could be colocated with the refueling station.

In the embodiment in which the drone(s) are resident in-vehicle, the image data transmission could take place from the in-vehicle drone station via a wireless connection, such as a cellular connection, to a “cloud based” image processing and pattern recognition remote processor and server. This embodiment offers an economical, flexible and timely inspection of an AV at end of trip.

In case of damage, or left-behind objects, the operator should be in immediate contact with the responsible occupant(s) and asset owner/manager via text and/or voice and email to their registered cell phone number or email address.

In certain evaluation instances, the vehicle will be held in place, or moved to an inspection area, but will not be sent to the next customer until damage resolution is attempted. A remote operator could view the images on his smarthpone or tablet, and could release drone(s) for a repeat or concentrate on certain areas of the AV. In case the AV is already at an inspection/refueling site, it could be sent to a further inspection or repair and maintenance site.

In case of damage, the images with date and time stamp will be made immediately available to the offending, responsible occupant and owner/manager.

In one embodiment the interior camera will need to communicate with the vehicle's in-dash system. The vehicle OEMs could refuse to make that communication available for various reasons, including Cyber security and vehicle safety. Therefore, our inspection system will require our own cellular chip/modem for a WAN in addition to BLE and/or WiFi for the LAN.

We will offer an in-vehicle drone/station with our novel camera system and air sampler that will be programmable for each make/type of vehicle and expected interior and/or exterior surfaces.

The results of the inspection analysis could be integrated with a robotic floor matt and seat fabric cleaner and vacuum system. The inspection data indicates the location and type of stain and will be used by the cleaning device to pinpoint the soiled spot with the proper robotic cleaner and vacuum. In some cases the damage or dirt will be on hard surfaces such as windows and dashboards.

Self inspection by the occupant with his or her own smartphone is also envisioned as an option. The phone app would need to be GPS enabled and also able to create photograph timestamp that ties time and location to time and location of vehicle for authentication purposes. In other words, we will be confident the the self inspection images are from the same vehicle that was used by the occupant. This feature will also allow for cooperation with the owner/manager(s) of the vehicle for vehicle ID and location at the time the photos were taken and time stamped by the occupant's smartphone. Also, the application would be designed to deter any image manipulation. This method has limited value because the occupant would be motivated to avoid images of any possible damage that he or she may have caused. On the other hand, this method would be valuable at the beginning of a trip by a new occupant in order to show existing damage prior to occupancy.

In the case of shared vehicle inspection and evaluation we have another instance of DataMuling as an advantageous use of the customer's smartphone to carry data to the network for processing and evaluation. In the case of shared vehicles, especially when there is no human present who is in authority to check in or check out vehicles, the prospective occupant takes on the liability of the previous occupant. In other words, the future customer, before he or she takes possession of the shared vehicle needs to know the status of the vehicle, both the exterior and interior. The exterior of the vehicle is easier to photograph and easier to discover dings or scratches. The interior of the vehicle is more problematic with many more surfaces and types of material that may hide hidden damage. The intent of this invention is to offer a high speed, accurate and cost effective way to quickly and easily gather interior status of a shared, AV and pass that information to the customer(s) and to the network.

As discussed above, there is a special camera and light source designed to capture this vehicle data. The system requires a means to get the data from the special drone/camera out to the network for processing, if the vehicle manufacturer does not wish to have the data pass through its data communication channels, such as cellular or WiFi or BLE. This restriction may be for various reasons, including vehicle network security reasons. In this case, the next occupant is prompted to capture the data from the inspection camera and send it in for processing and evaluation. The transmission between the inspection device and the occupant's smartphone should be encrypted. The occupant will also see the results of the evaluation following image processing on his or her phone and this will be the same image presented to the network for evaluation.

The Use Case Scenario can Proceed in these Steps:

Prospective occupant requests the most recent inspection images for an AV. The prospective occupant will check these images against the latest damage report for the vehicle. This is also common with rental vehicles, but there is usually a company employee assisting the renter as he or she checks for any damage.

Prior to gaining access to an AV the shared owner or lessee of the vehicle can request interior inspection photos and analysis. In some instances damage can be noticed just as the occupant enters the vehicle. The inspection image(s), which may be in the form of a short video, can be transmitted from the inspection camera wirelessly to the prospective customer's phone, where it can be viewed immediately, and the image(s) can also be DataMuled from the customer's phone to a remote network server. This process is for the occupant's protection and avoids liability for previous damage to a shared vehicle.

Further on this point, if the previous occupant was a bad actor, he or she would not want to make an image of the interior. The bad actor will depart and hope for the best case in which their damage is not detected until after other occupants had access to the vehicle.

A prospective occupant who is taking possession of the vehicle will want to see if there was any damage. Therefore, the incoming occupant is motivated to request the initial inspection photo and is sent (via wireless) to his/her phone for viewing and this data could also be data muled up to the remote servers and database.

If the previous occupant was a good actor, so to speak, then he or she will want to have an inspection photo taken at the the end of trip so that they are not responsible for the next occupant's damage, if any.

The inspection photo could be triggered when the vehicle senses there was a BLE smartphone(s) in the cabin (whether paired or not) and now the smartphone is gone and also the AV is in “park”.

In one embodiment, the camera system has an accelerometer. The camera will also have BLE, WiFi, and other wireless communications available. The protocol could be to automatically capture interior images if the vehicle is not moving and if no BLE communication is present. If no vehicle movement and no smartphones present; then (release drone) take inspection photos while assuming end of trip.

Therefore, the inspection images can go from the vehicle drone/camera to the departing occupant, also to the incoming occupant, and the same images optionally via DataMule to the remote image processing server.

In another embodiment, in which the camera communication network is tied to the vehicle's comm network, the process is tied to a occupant's digital certificate (reservation)—similar to a digital room key—and to a biometric measurement.

The incoming occupant has a choice; accept or reject the vehicle based on their inspection evaluation. If not acceptable, the occupant can notify the AV network owner and request another vehicle. If rejected, the prospective occupant can use the authentic, location and time stamped inspection image as evidence to defend the decision to reject.

In another case, the occupant exits vehicle, and requests an inspection at end of trip. The inspection request could be a button to press as part of a vehicle fueling smartphone application.

In another case, an accelerometer in the camera system inside the vehicle senses the vehicle is not moving, and automatically gathers interior images from a fixed camera or launches an interior drone from a station in the vehicle. When the next occupant enters, his or her phone pairs wirelessly with the camera's LAN, the latest photo is communicated to the new occupant's phone and can also be DataMuled to a remote, secure server.

Therefore, based on the inspection process, the inspection photos are the incoming occupant's insurance policy and also any bad actor's proof of liability.

We have to plan for an inspection camera product that could integrate with the vehicle in case the OEM's accept our product in the future. This could simply be implementing the camera's BLE with the vehicle and not allowing other BLE devices to interfere.

Or, there is only BLE to the outgoing and incoming customers' phones. If good actors, they are both motivated to grab the photo on their phones to protect themselves. If bad actors, they will not be motivated. Even if the incoming customer is a bad actor, he will want to protect himself. Unless, next occupant is inebriated or otherwise incapacitated when he or she enters the AV. Shared EV network members would want to have their AV access inspection application on automatic with our system in order to protect themselves as they enter a shared AV.

In an embodiment intended for larger AVs, such as vans or buses, the occupants will be advised to remain seated while the drone passes up and down the center aisle of the AV.

### Inspection System Components and Processes:

A camera and sensor system is typically required. At least one camera with optional special filter(s) and at least one optional sensor, an optional air sampler cartridge and a self-contained LED light source comprised of various wavelengths of visible and invisible light.

A means for controlling the camera/sensor/LED movement in and around the AV. In one preferred embodiment this would be a drone, or a plurality of drones.

In another embodiment the camera rests on a telescoping arm whose base unit can be centrally located at the front or the rear of the vehicle. The front located telescoping arm would face to the rear and a rear located arm would face to the front. Also, the base would be mounted relatively high in the vehicle or on the ceiling. One possible location would be near the sunglass holder at the top forward light console in many vehicles. This space would become vestigial in upcoming fully enabled AVs. And yet there will be a need for a central interior lighting system in all AVs. So this sunglass compartment could be used as the base for the telescoping arm and camera/LED assembly. The base could have an optional air sampling system to sample the air and determine if common undesirable, odors are present.

The telescoping arm could also carry an LED light source that in one embodiment shines a powerful beam of a cylindrical shape along the surfaces of the interior of the AV from front to rear or vice versa, building an image of the interior of the vehicle.

A means for communicating a map of the interior space and outside dimensions of a series of models of AVs to the inspection drone's flight control system.

A secure in-vehicle drone docking station comprising GPS, optional accelerometer, battery charger, LAN wireless communications for drone to docking station image uploads, WAN wireless communications for image uploads to remote server and firmware upgrades from remote server.

In another embodiment the drone station is co-located on or near the charging station, that charger could be conductive or inductive. The drone(s) leave from and return to that station. The drone station has drone charging capabilities, and also can communicate via wired or wireless communications with the drone. Images and data can travel to and from the drone and the drone station.

The drone station and charging station could share WAN communications through a wired or wireless connection.

The drone station, whether interior or exterior to the vehicle, can also accept an air sample cartridge for analysis and data transmission to a remote database.

An exterior mounted drone station, such as colocated with a refueling/charging station, in an unsecured area, can have a secure door, such as a small roll up door, that protects the drone until a vehicle arrives for inspection. During inspection, the drone station door could open allowing the drone to exit and one or more windows on the vehicle would be lowered sufficiently to allow the drone to enter the vehicle. Doors and windows could close during the inspection and open to allow drone to exit the vehicle and return to the drone station. All doors and windows could close again for security purposes.

In one embodiment the drone station is mounted in the interior of the vehicle at the rear window and includes a small solar panel facing outdoors so that solar energy could trickle charge a battery in the drone station.

An application residing on the server that gathers image data and performs pattern recognition operations in conjunction with a library of known vehicle exterior and interior shapes and patterns.

An application that stores and tracks images of known vehicles at each end of trip.

An application that compares images of a vehicle at end of trip with known images from previous end of trip and examines for changes.

A means of communication from the image processing center to a vehicle asset owner in case of negative change from previous end of trip image. A means of accepting or rejecting detected changes.

A means of wireless communications from image processing center back to in-vehicle drone station and ongoing LAN communication to an occupant's smartphone.

An optional means of wireless communications directly from the image processing center to the responsible occupant's smartphone.

A means for wireless communication of inspection findings to a cleaning or repair system, indicating location and source of stain or damage, whether interior or exterior.

A robotic cleaning system is envisioned with multiple cleansers, spray or foam capability with rotating brush action followed by a dry/vacuum cycle.

Two separate cleaning systems are envisioned:

One system deploys individual robo scrubbers on each surface of the vehicle, such as floor matts and seats.

An alternative system deploys a robot arm into the vehicle. A cleaning extension is placed on the end of the robot arm. It is possible to have one arm for the front seats and dashboard another arm for the back seats and rear windows. A third robotic arm could be used for the rear luggage area.

Several descriptions have been presented to aid in understanding the present invention. One skilled in the art will realize that numerous changes and variations may be made without departing from the spirit of the invention. Each of these changes and variations is within the scope of the present invention.

We claim:

1. An automated vehicle inspection system comprising:
a plurality of cameras covering at least the visible spectrum and near infrared (IR), each camera having a wide field of view;
the cameras comprising of at least one or more sensors, and at least one or more lenses designed to gather and focus light waves in the visible and near IR;
at least one LED light source placed at or near the cameras, said LED light source offering a source of broad spectrum light, similar to daylight.

2. The automated vehicle inspection system of claim 1 wherein the at least one LED is configured to flash and temporarily flood the interior of the vehicle with a broad spectrum of light.
